(19) United States
(12) Patent Application Publication
(10) Pub. No.: US 2016/0269864 A1
(43) Pub. Date: Sep. 15, 2016

(54) DISPLAYING SOCIAL MEDIA CONTENTS AND ALERTS FROM LOCATION-BASED SOCIAL MEDIA MONITORING ON WEARABLE DEVICES

(71) Applicant: WeLink, Inc., San Jose, CA (US)

(72) Inventor: Karthik Mavaneethan Manimaran, San Jose, CA (US)

(21) Appl. No.: 14/656,539

(22) Filed: Mar. 12, 2015

(51) Int. Cl. H04W 4/02

(52) U.S. Cl. CPC H04W 4/025

(57) ABSTRACT

Embodiments of an information management system and related methods are disclosed. In some embodiments, the system collects social media contents and metadata from social media networks or other sources. The system then enhances the received social media data with location and other information. Furthermore, the system receives from a client device a request for registering a computing device, such as a wearable device. The system also receives from the client device a request for receiving certain social media data or notifications thereof on the registered device, as well as a set of criteria characterizing the certain social media data, including one related to location. In response to the requests, the system determines which portion of the enhanced social media data meets the set of criteria, converts the determined portion to a format specific to the type of the registered computing device, and delivers the converted data to the registered computing device.

### RELATED APPLICATION

The present application is related to U.S. patent application Ser. No. 14/656,252, filed Mar. 12, 2015 and titled “COLLECTING AND GENERATING GEO-TAGGED SOCIAL MEDIA DATA THROUGH A NETWORK ROUTER INTERFACE”, which is incorporated by reference in its entirety.

### TECHNICAL FIELD

The present application is related to social media data and wearable devices and, in particular, to providing location-based social media data and related data to wearable devices.

### BACKGROUND

Communication is shifting from traditional platforms—such as phone and paper—to digital media. Among the notable digital media are email, blogs, and social media networks. The social media networks include Twitter, Instagram, Facebook, Google Plus, YouTube, Flickr, Picasa, Foursquare, Nextdoor, Pinterest, Yelp, 500px, Photobucket, Panaromio, Meetup, Eventbrite, Dailymotion, Viddy, Soundcloud, YikYak, Snapchat, Whisper, Secret, TripAdvisor, Expedia, Travelocity, etc. As they keep individuals socially connected, social media data has also attracted the attention of various businesses, which analyze such data to extract behavioral patterns and other useful information regarding social media users. Given the volume of and interest in social media data, it would be useful for individuals and businesses to quickly access relevant portions of the social media data.

In conjunction, wearable devices, such as Google Glass, Android Wear, and Apple Watch, are gaining popularity as people are seeking more technological devices, especially those that are easy to use, to simplify their tasks and daily activities. As wearable devices become smarter and more integrated with the environment around them, individuals and businesses are seeking to maximize the benefits of wearable devices. One potential benefit that can come from these wearable devices is allowing timely access to relevant social media content.

### BRIEF DESCRIPTION OF THE DRAWINGS

Various embodiments are disclosed in the following detailed description and accompanying drawings.

FIG. 1 is an environment diagram illustrating an example environment in which an information management system disclosed in the present application can operate.

FIG. 2 illustrates example components of the information management system.

FIG. 3 illustrates an example social media communication that can be included in the social media data received by the information management system.

FIG. 4 illustrates an example layout for displaying social media data and related notifications created by the information management system on the screen of a wearable device.

FIG. 5 illustrates an example process performed by the information management system of identifying social media data of interest to a user and delivering the identified social media data or notifications thereof to a wearable device chosen by the user.

FIG. 6 is a high-level block diagram showing an example architecture of a computer, which may represent any electronic device, any server, or any node within a cloud service as described herein.

### DETAILED DESCRIPTION

The present application discloses an information management system and related methods which enhance social media data with location information; allow users to specify their interests in social media data based on various criteria, such as location-related information, and their choices of devices, including a wearable device; and deliver those social media data that satisfy the specified criteria or notifications thereof to the chosen devices. The system includes an integration platform that works with different types of user-chosen devices that may be associated with different hardware requirements and application programming interfaces (APIs).

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and the equivalent.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

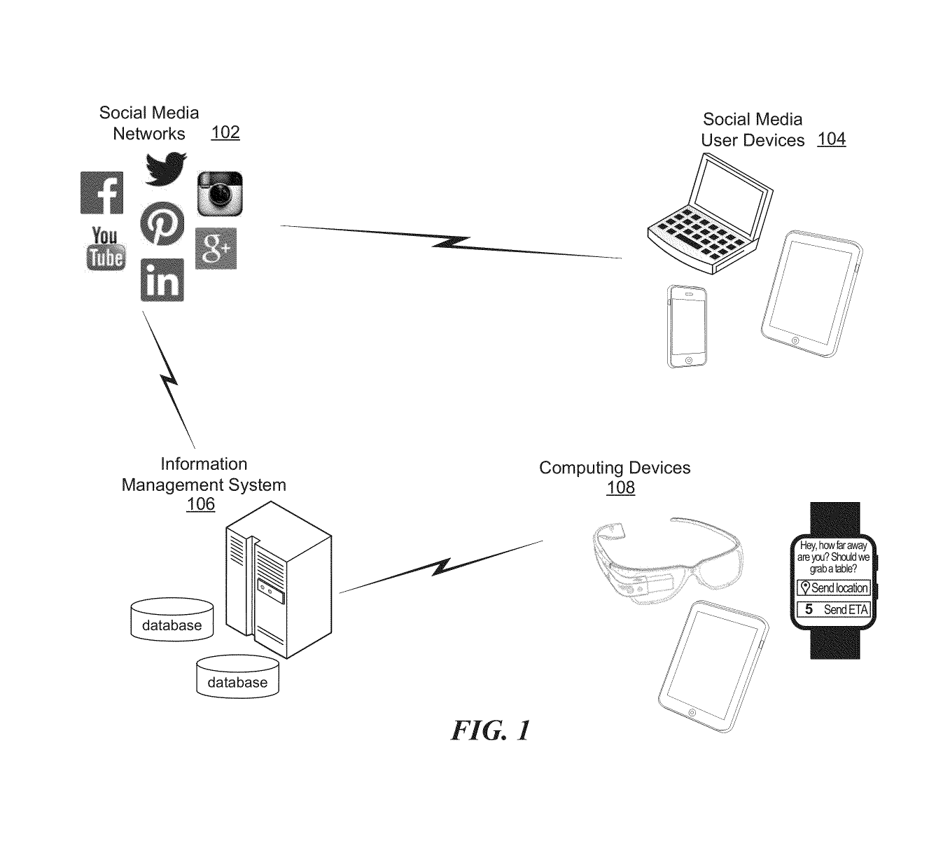

FIG. 1 is an environment diagram illustrating an example environment in which the information management system can operate. In some embodiments, the information management system 106 comprises servers and databases that possess sufficient data storage and processing power as well as networking and communication capabilities. In general, users of social media networks 102, maintained by companies such as Facebook, Twitter, and Instagram, produce social media contents through user devices 104, such as mobile phones, tablets, laptop computers, desktop computers, and wearable devices. In particular, wearable devices can include smart glasses, watches, wristbands, virtual reality headsets, etc. These user devices 104 transmit the social media contents to the social media networks 102 across computer networks, such as the Internet. In turn, the system 106 receives the social media contents and metadata from these social media networks 102, social media plugins, or social media data collectors, such as Firehose, which aggregate social media data streams through computer networks. The social media metadata can include information identifying a social media user, the user's device, the user's location, and so on. The system 106 can enhance the received social media data with additional information to increase its value, such as additional location information.

In some embodiments, the information management system 106 also receives data from computing devices 108 of users of the system 106 through computer networks. The system 106 can offer a specific graphical user interface (GUI) to be accessed remotely. The system 106 can also deploy a client component, which can be implemented as a mobile application, to one or more of the computing devices 108 and can communicate with the computing device through the client component. The computing devices 108 can similarly include mobile phones, tablets, laptop computers, desktop computers, or wearable devices. The data received from the computing devices 108 can indicate the users' interests in select social media data in terms of various criteria, such as author, location, timestamp, or keywords. The received data can also specify the same computing devices 108 or different devices, including a wearable device, where the social media data of interest or notifications thereof are to be delivered. In response to receiving data from one of the computing devices 108, the system 106 matches the indicated criteria against the received or enhanced social media data to identify the social media of interest to the corresponding user of the system 106. The system 106 then generates the identified social media data or notifications thereof in an appropriate format according to the type of destination device specified by the user. Finally, the system 106 delivers the generated data to the user-specified device directly or through a client component across computer networks.

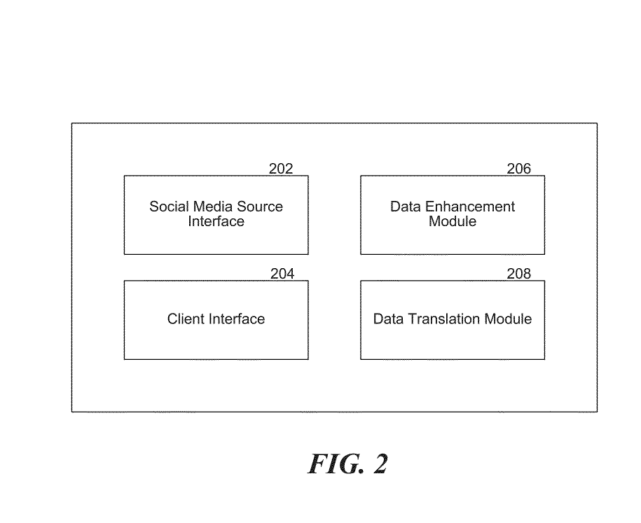

FIG. 2 illustrates example components of the information management system. In some embodiments, the system includes a social media source interface 202, a data enhancement module 206, a client interface 204, and a data translation module 208.

In some embodiments, the social media source interface 202 manages interactions with social media sources, including social media networks, social media plugins, and social media data collectors. The social media source interface 202 obtains social media contents and metadata from these social media sources through a published application programming interface (API) or any other specified access mechanism. For example, Facebook makes data available through an API, while Firehose delivers data in a supported format, such as JSON. The social media data can also obtained from crawling social media websites. The social media data can be received on a daily basis, upon a specific request from a computing device, or according to any other schedule.

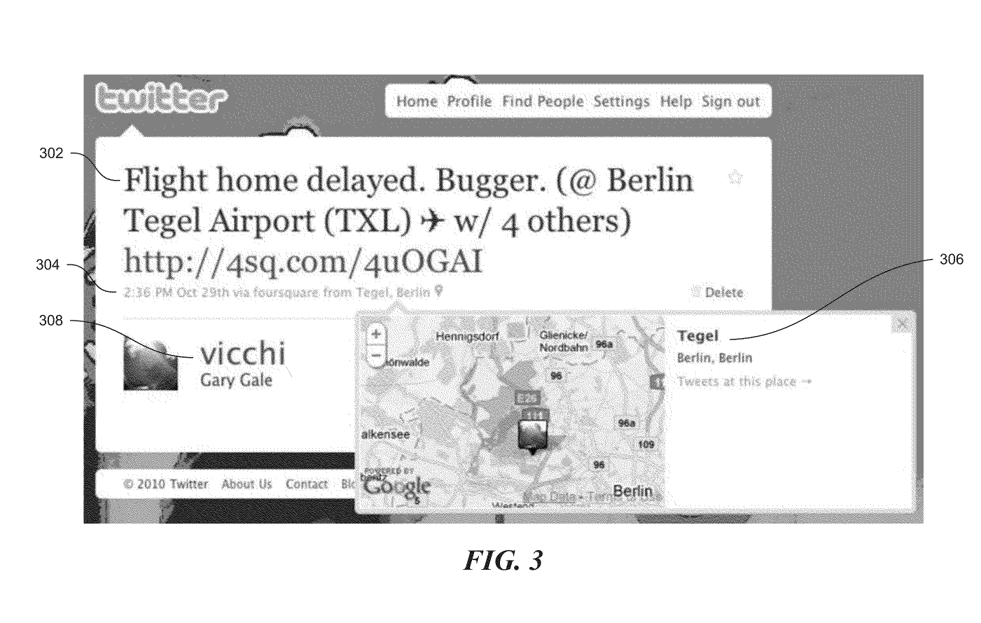

FIG. 3 illustrates an example social media communication that can be included in the social media data received by the information management system. The data corresponds to a tweet. The tweet includes a message 302, which is normally considered to be the content of the tweet and includes text but could include other types of data, such as images and videos. The content may be dissected to deduce various types of information regarding the social media user or the author of the message. For example, the word “flight” may indicate that the user is travelling, the word “bugger” may indicate frustration, the words “Tegel Airport” and “(TXL)” may indicate the user's current or recent location, and the uniform resource location (URL) “http://4sq.com/4uOGAI” and the referenced content may indicate additional interests of the user. The tweet also includes author information 308 indicating who composed and sent the message, time information 304 indicating when the message was sent, and location information 306 indicating where the message was sent from. Such information can be considered part of the content or, as is more common, part of the metadata of the tweet. Not all types of metadata may exist for a tweet. For example, when a user does not turn on the geotag feature, the location information would not be stored with the content. On the other hand, metadata besides user, location, and time information may be stored with the tweet depending on the collector of the social media data. For example, together with the message, Firehose may make available language information indicating in which language the message was written and klout information indicating the user's influence ranking. The content and the metadata can both be analyzed to determine attributes and activities of the author.

In some embodiments, the data enhancement module 206 enriches the social media contents and metadata received from the social media sources. One factor that is important for analyzing social activities is user location. However, not every piece of social media data includes location information. For example, location services are turned off by default with Twitter, so a user needs to turn on the location services to attach a location to a tweet. Therefore, one way the data enhancement module 206 can enrich the received social media data is to uncover as much location information as possible.

As discussed in the related application U.S. patent application Ser. No. 14/656,252, the information management system can collect information from network routers and use the information to enrich social media data received from various social media sources. In some embodiments, the data enhancement module 206 first relies on a data aggregator to collect router data from network routers regarding a network router, devices connected to the network router, or users using the connected devices. Specifically, the router data can include the location of the network router and for a connected device, the MAC address and locations of visited websites together with the times of visits. The data enhancement module 206 then joins the network router data to the social media data mainly based on timestamps.

In some embodiments, the data enhancement module 206 enhances the social media data in various ways based on the joined data. In one approach, when a first and a second devices are connected to the same network router, even if the social media data transmitted by the first device does not include location information, if the network router is associated with location information or if the social media data transmitted by the second device includes location information, the data enhancement module 206 can assign the same location information to the social media data transmitted by the first device since both devices are connected to the same network router and thus are typically located in the proximity of the router. In addition, based on the MAC address of the first device, even if the first device later is connected to a different network router or communicates with a different social media network, the data enhancement module 206 can associate the published social media data with the same first device and its user to obtain more information about the user. The information generated by a network router can include additional detail, such as device types, timestamps of online activities performed outside the social media, etc., which can also be used to enrich the received social media data and make additional inferences regarding the social media users.

In some embodiments, the client interface 204 manages interactions with client devices, such as mobile phones, tablets, laptop computers, desktop computers, and wearable devices. The client interface 204 receives, from a client device of a user, data for registering one or more computing devices on which to receive social media data of interest to the user or notifications thereof, including a wearable device. The registration data can include a name, a make and model, and other device information regarding each computing device. The client interface 204 can deploy a client component, such as a mobile application, to any of the computing devices, and can communicate with the computing device through the client component. For the deployment, the client interface 204 would engage in an authorization process with the computing device to allow the client interface 204 to access the computing device. For example, the authorization process can be performed in accordance with the OAuth standard to allow the computing device to provide such authorization without sharing any credentials with the client interface 204. The client interface 204 also allows the client device to specify a set of criteria identifying the social media data of interest, in terms of the contents or the metadata. For example, one criterion can be any social media contents that contain a specific keyword, another criterion can be any social media contents associated with a specific location or a specific timeframe, and yet another criterion can be any social media contents published by someone with a certain Klout.

In some embodiments, the client interface 204 further receives from the client device specifications of how the social media data of interest or the notifications thereof are to be delivered to the registered computing devices, including a wearable device. The user can specify that data are to be delivered to a specific registered device according to a distinct schedule. The user can also specify that only data that satisfy certain criteria are to be delivered to a specific registered device. As one example, the user may jog every morning wearing a smart fitness wristband, and the user would like to learn about social updates from the user's family during that time. The user can then specify that notifications of social media contents published by the user's family members are to be delivered to the user's fitness wristband everyday between six and eight o′clock in the morning. As another example, the user may be the marketing director of a company and would like to stay informed of any discussions of the company's products on social media networks. The user can then specify that notifications of social media contents that mention the names of the company or its products are to be delivered, as soon as such contents become available, to the smart watch that the user routinely wears to work. According to the specifications received from the client device, the data translation module 208 generates appropriate data for delivery as discussed below, and the client interface 204 delivers the generated data to the appropriate devices at appropriate times across computer networks.

In some embodiments, the data translation module 208 generates social media data or notifications thereof to be delivered to the registered computing devices. For a client device and the user thereof, the data translation module 208 matches the user-specified criteria against the social media data enhanced by the data enhancement module 206 to identify the social media data of interest. The match, which can be precise or fuzzy, can be performed using any technique known to someone of ordinary skill in the art, such as a classification or learning method applicable to text, image, video or other types of data. The data translation module 208 then identifies the computing devices to which the matching social media data or notifications thereof should be delivered.

Different computing devices can have different hardware requirements, APIs, and other specifications. In general, when a registered device is a wearable device with a relatively small display screen, the registered device would show only limited information at a time. One implication is that data that can normally be presented on a single screen on a handheld device might need to be presented in a condensed manner or split up into data chunks for display on multiple screens. Accordingly, the data translation module 208 would adjust the data to be displayed on the computing device chosen by the user. For example, an indication of new social media data of interest can be displayed in a distinct, small area, or it can simply be shown by flashing the background of the entire display area so as not to use up additional space.

In addition, some wearable devices may implement an “action” mechanism through which the user can trigger some action, such as adding a “Like” to certain social media contents, while other wearable devices may allow only static content viewing. In some embodiments, the data translation module 208 can adjust the data to be displayed on the computing device chosen by the user. For example, when an action mechanism is available, the data translation module 208 can compose data for a screen which includes mainly metadata for new social media contents of interest, such as title, author, and location, as well as an action button which, when pressed, triggers the display of a portion of the social media contents. When no action mechanism is available, the data translation module 208 can compose similar data for a screen and rely on built-in mechanisms, including hardware features, which may be available for retrieving additional data for the screen. The data translation module 208 can also include in the data for one screen a summary of the social media data, such as the first two lines, or the entire social media contents that can subsequently be magnified using available built-in features, as an alternative to displaying portions of the social media contents on another screen.

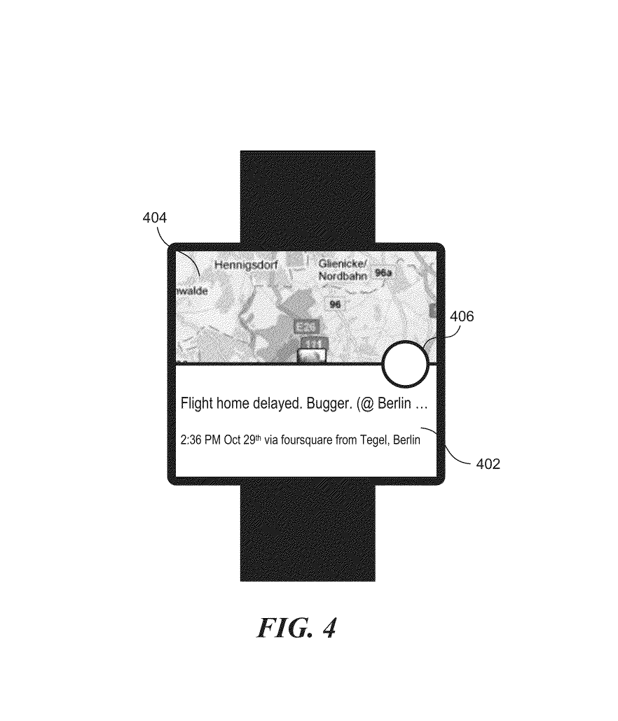

FIG. 4 illustrates an example layout for displaying location-based social media data of interest and related notifications created by the information management system on the screen of a registered wearable device. In this example, the registered wearable device is a smart watch. The system includes a summary of the social media data of interest together with an associated geotag for display in the lower portion 402 of the screen, and a map for the region corresponding to the geotag in the upper portion 404. The system can also allow a user to adjust various parameters associated with the display, such as the default scale for the social media contents (title only, first two lines, entire contents, etc.) and the default scale for the map (block, town, city, state, etc.). In addition, the system shows the arrival of new social media of interest through a simple indicator 406, which can change colors, intensities, illumination patterns, etc.

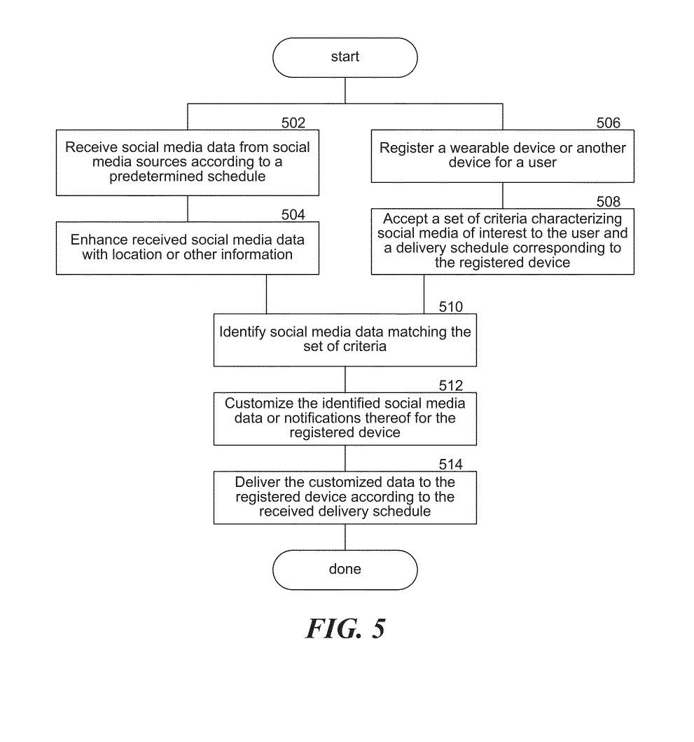

FIG. 5 illustrates an example process performed by the information management system of identifying location-based social media data of interest to a user and delivering the identified social media data or notifications thereof to a wearable device chosen by the user. In step 502, the information management system receives social media data from social media sources, such as social media networks, social media plugins, or social media collectors. It can pull data from these sources from time to time or arrange for automatic delivery by these sources according to specific schedules. To ensure that the data delivered to a user is relatively up-to-date, the communication with the social media sources should be sufficiently frequent. In step 504, the system enhances the received social media data with additional information, including location information. Using additional location data from a network router, for example, the system can associate a new geotag with a social media posting or strengthen an existing geotag with additional detail.

In conjunction, the information management system receives and fulfills requests from a client device. The system can deploy a client component, which can be implemented as a mobile application, to the client device, and can communicate with the client device through the client component. Therefore, in step 506, the system receives requests from a client device of a user to register a computing device, such as a wearable device, and performs the registration accordingly. The registration data can include basic device information regarding the name, make, model, color, display size, supported networks, etc. It can also include the user's authorization for the information management system to access the registered device. In step 508, the system further receives a set of criteria characterizing the social media data of interest to be delivered to the registered device and a schedule according to which the delivery is to be made. The set of criteria can involve the keywords in social media contents or other information in associated metadata, regarding the time of content publication, the author's location, etc. The user can also specify how the criteria are to be matched, such as whether the criteria need be met simultaneously, how they should be weighted, and so on. The schedule can be periodic, involving specific times during a day, days during a week, etc., or it can specify any specific dates and times.

In step 510, the information management system determines the social media data that match the set of criteria. The system can utilize any matching or classification technique and related methods known to someone of ordinary skill in the art, taking into consideration the user-specified matching restraints, such as that at least 50% of all the criteria need to be met at the same time, or at least 40% of the high-priority criteria and 30% of the low-priority criteria need to be met at the same time. In step 512, the system organizes and formats the matching data to satisfy the requirements of the registered device. For example, the data may need to be edited with specific markup, split into portions each under a specific size, etc. In step 514, the system delivers the customized data to the registered device in accordance with the user-specified delivery schedule.

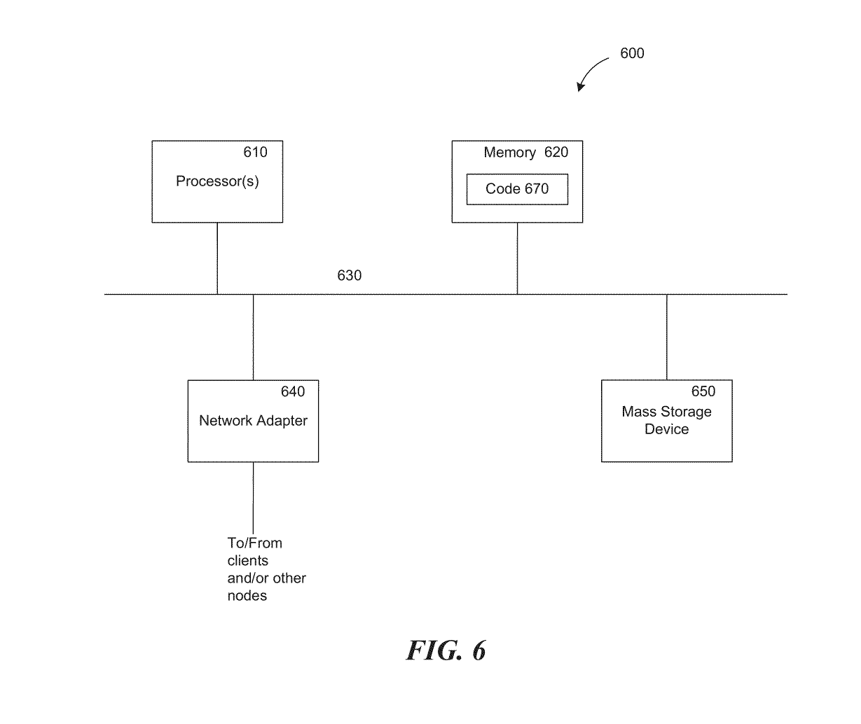

FIG. 6 contains a high-level block diagram showing an example architecture of a computer, which may represent any electronic device, such as a mobile device or a server, including any node within a cloud service as described herein, such as may implement the operations described above. The computer 600 includes one or more processors 610 and memory 620 coupled to an interconnect 630. The interconnect 630 shown in FIG. 6 is an abstraction that represents any one or more separate physical buses, point-to-point connections, or both, connected by appropriate bridges, adapters, or controllers. The interconnect 630, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), an IIC (I2C) bus, or an Institute of Electrical and Electronics Engineers (IEEE) standard 1394 bus, also called “Firewire”.

The processor(s) 610 is/are the central processing unit (CPU) of the computer 600 and thus control the overall operation of the computer 600. In certain embodiments, the processor(s) 610 accomplish this by executing software or firmware stored in memory 620. The processor(s) 610 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or a combination of such or similar devices.

The memory 620 is or includes the main memory of the computer 600. The memory 620 represents any form of random access memory (RAM), read-only memory (ROM), flash memory, or the like, or a combination of such devices. In use, the memory 620 may contain code 670 containing instructions according to the techniques disclosed herein.

Also connected to the processor(s) 610 through the interconnect 630 are a network adapter 640 and a mass storage device 650. The network adapter 640 provides the computer 600 with the ability to communicate with remote devices over a network and may be, for example, an Ethernet adapter. The network adapter 640 may also provide the computer 600 with the ability to communicate with other computers.

The code 670 stored in memory 620 may be implemented as software and/or firmware to program the processor(s) 610 to carry out actions described above. In certain embodiments, such software or firmware may be initially provided to the computer 600 by downloading it from a remote system through the computer 600 (e.g., via network adapter 640).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware used for implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer-readable medium that can direct a computer, other programmable data processing apparatus, or other devices to function in a particular manner, such that the instructions stored in the computer-readable medium produce an article of manufacture, including instructions which implement the function/act specified in the flowchart and/or block diagram block or blocks.

The computer program instructions may also be loaded onto a computer, other programmable data processing apparatuses, or other devices to cause a series of operational steps to be performed on the computer, other programmable apparatuses or other devices to produce a computer-implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It should also be noted that each block of the block diagrams and/or flowchart illustrations, and combinations of blocks in the block diagrams and/or flowchart illustrations, can be implemented by special-purpose hardware-based systems that perform the specified functions or acts or by combinations of special-purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some, but not necessarily all, embodiments of the inventions.

It is to be understood that the phraseology and terminology employed herein are not to be construed as limiting and are for descriptive purposes only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

1. A computer-performed method of providing location-based social media data to user devices, comprising:
receiving, by a processor, router data from one or more network routers;
receiving, by the processor, social media data from a data provider;
enhancing the social media data with location information based on the router data;
receiving, by the processor, a registration request from a first user device,
wherein the registration request is for registering a second user device, and
wherein the registration request includes location data;
selecting from the enhanced social media data a set of social media data based on the registration request; and
delivering the selected social media data to the second user device based on the registration request.

2. The computer-performed method of claim 1,
wherein the router data includes first data from one of the network routers regarding a first visit by a first device of a first website associated with a first content provider,
wherein the first device is connected to the one network router and associated with a first user,
wherein the router data includes second data from the one network router regarding a second visit by a second device of a second website associated with a second content provider,
wherein the second device is connected to the one network router and associated with a second user,
wherein the social media data includes first details originally published in a first publication by the first content provider and is not tagged with a physical location, and
wherein the social media includes second details originally published in a second publication by the second content provider and is tagged with a first physical location.

3. The computer-performed method of claim 2, wherein the enhancing includes tagging the first details with the first physical location upon determining that:
a first time associated with the first publication matches a second time associated with the first visit, or the first time falls in a time range in which the first device is connected to the one network router when the first details are created by the first user, and
a third time associated with the second publication matches a fourth time associated with the second visit, or the third time falls in a time range in which the second device is connected to the second network router when the second details are created by the second user.

4. The computer-performed method of claim 2,
wherein the router data includes information on a second physical location of the one network router, and
wherein the enhancing includes tagging the first details with the second physical location upon learning that a first time associated with the first publication matches a second time associated with the first visit, or the first time falls in a time range in which the first device is connected to the one network router when the first details are created by the first user.

5. The computer-performed method of claim 1,
wherein the registration request includes a list of one or more criteria for selecting social media data, including a location-based criterion, and
wherein the selecting is performed in accordance with the list of criteria.

6. The computer-performed method of claim 5, wherein the list of criteria includes a keyword, a timeframe, a user name, a number of followers, or a number of acknowledgments.

7. The computer-performed method of claim 1, wherein the registration request includes a list of one or more settings regarding the second user device, including a display-related setting.

8. The computer-performed method of claim 7,
wherein the list of settings includes a brand name or a brand model of the second user device, and
wherein the list of settings includes dimensions, resolution, or navigation structure of a screen on the second user device.

9. The computer-performed method of claim 7, further comprising determining a layout for displaying the selected social media data on the second user device in accordance with the list of settings.

10. The computer-performed method of claim 9, wherein the determining includes deciding whether to split data into multiple screens, choosing an amount of detail to include in a screen, or arranging items to be included in a screen.

11. The computer-implemented method of claim 9, wherein the layout includes an area for a map corresponding to the location data included in the registration request.

12. The method of claim 1, wherein the registration request includes a schedule for delivering the selected social media data to the second user device.

13. The computer-implemented method of claim 1, wherein the registration request includes an authorization for accessing the second user device.

14. The computer-implemented method of claim 1, wherein the network routers include a wireless network router.

15. The computer-implemented method of claim 1, wherein the first user device or the second user device is a laptop computer, a tablet, a mobile phone, or a wearable device.

16. The computer-implemented method of claim 1, wherein the first user device and the second user device are identical.

17. A system for providing location-based social media data to user devices, comprising:
a processor and memory, cooperating to function as:
a first receiving unit configured to receive network router data and social media data;
an enhancing unit configured to enhance the social media data with location information based on the network router data;
a second receiving unit configured to receive a registration request including location data from a first user device;
a selecting unit configured to select from the enhanced social media data a set of social media data based on the registration request; and
a delivering unit configured to deliver the selected social media data to a second user device based on the registration request.

18. The system of claim 17,
wherein the registration request includes a list of one or more criteria for selecting social media data, including a location-based criterion, and
wherein the selecting unit selects the set of social media data in accordance with the list of criteria.

19. At least one tangible computer-readable medium storing instructions, which when executed by at least one data processing device, perform a method of providing location-based social media data to user devices, the method comprising:
receiving, by a processor, router data from one or more network routers;
receiving, by the processor, social media data from a data provider;
enhancing the social media data with location information based on the router data;
receiving, by the processor, a registration request from a first user device for registering a second user device,
wherein the registration request includes location data;
selecting a portion of the enhanced social media data based on the registration request; and
delivering the portion of the enhanced social media data to the second user device based on the registration request.

20. The At least one tangible computer-readable medium of claim 19, wherein the registration request includes a list of one or more settings regarding the second user device, including a display-related setting.
